(19) United States
(12) Patent Application Publication
(10) Pub. No.: US 2025/0214776 A1
(43) Pub. Date: Jul. 3, 2025

(54) PICKING METHOD, PICKING VEHICLE AND PICKING SYSTEM

(71) Applicant: INDUSTRIAL TECHNOLOGY RESEARCH INSTITUTE, Hsinchu (TW)

(72) Inventors: Chen-Jyh FAN, Hsinchu County (TW); Wan-Ru HUANG, Hsinchu County (TW); Lih-Guong JANG, Hsinchu City (TW); Sheng-Yu WU, Changhua City (TW); Yu-Lin SHIH, New Taipei City (TW)

(73) Assignee: INDUSTRIAL TECHNOLOGY RESEARCH INSTITUTE, Hsinchu (TW)

(21) Appl. No.: 18/399,122

(22) Filed: Dec. 28, 2023

(51) Int. Cl. B65G 1/137; B65G 1/04

(52) U.S. Cl. CPC B65G 1/1375; B65G 1/0492

(57) ABSTRACT

A picking method, a picking vehicle and a picking system. The picking method includes: obtaining a current volume data and a current weight data of a box; generating a current arranging position data of the box based on the current volume data, the current weight data and an arranging position model of an artificial intelligence model. The arranging position model includes multiple arranging date each including a predetermined volume data, a predetermined weight data and a predetermined arranging position data that are corresponding to one another; and moving the box to a target arranging position via a picking vehicle based on the current arranging position data.

### TECHNICAL FIELD

The disclosure relates to a picking method, a picking vehicle and a picking system.

### BACKGROUND

Recently, the rapid development of the online shopping leads to significant demand of labor in logistics industry. However, picking the goods manually not only causes labor shortage but also is hard to control the stack of the goods. For example, when the goods are manually moved and stacked, the goods may be misaligned in the rack or even may protrude out of the rack, and the occupancy rate of the rack can hardly be maintained to be higher than a desired level.

### SUMMARY

The disclosure is to provide a picking method, a picking vehicle and a picking system effectively realizing the automation of the picking process.

One embodiment of this disclosure provides a picking method including: obtaining a current volume data and a current weight data of a good; generating a current placing position data of the good based on the current volume data, the current weight data and a placing position model of an artificial intelligence model, wherein the placing position model comprises a plurality of placing data, and each of the plurality of placing data comprises a plurality of groups of a predetermined volume data, a predetermined weight data and a predetermined placing position data that are corresponding to one another; and moving the good to a target placing position via a picking vehicle based on the current placing position data.

Another embodiment of this disclosure provides a picking vehicle configured to move on a supporting surface and including a movable base, a mounting platform, at least one fork and a pushing component. The movable base is configured to move on the supporting surface. The mounting platform is movably disposed on the movable base and has a mounting surface facing away from the supporting surface. The at least one fork is movably disposed on the mounting surface of the mounting platform. The pushing component is movably disposed on the mounting surface of the mounting platform. The at least one fork is located between the pushing component and the mounting surface.

Still another embodiment of this disclosure provides a picking system configured to pick one or more goods and including a controller, a supply apparatus, at least one rack and at least one picking vehicle. The supply apparatus is electrically connected to the controller and configured to transport the one or more good. The at least one rack is located on a side of the supply apparatus. The at least one picking vehicle includes a movable base, a mounting platform, at least one fork and a pushing component. The movable base is configured to move between the supply apparatus and the at least one rack on a supporting surface and electrically connected to the controller. The mounting platform is movably disposed on the movable base and has a mounting surface facing away from the supporting surface. The at least one fork is movably disposed on the mounting surface of the mounting platform and configured to support the one or more good. The pushing component is movably disposed on the mounting surface of the mounting platform. The at least one fork is located between the pushing component and the mounting surface. The pushing component is configured to push the one or more goods supported by the at least one fork into the at least one rack.

According to the picking method, the picking vehicle and the picking system disclosed by above embodiments, the current placing position data of the good is generated based on the current volume data, the current weight data and the placing position model of the artificial intelligence model. Thus, the trained artificial intelligence model can determine the optimized placing position of the good based on the volume and weight of the good. In this way, not only the goods are prevented from being misaligned in the rack or protruding out of the rack, but also the occupancy rate of the rack is allowed to be higher than a desired level, thereby effectively realizing the automation of the picking processes.

In addition, by the fork and the pushing component that are movably disposed on the mounting surface of the mounting platform, the picking vehicle can move the good and push the good into the rack. Accordingly, the automation of the picking processes is effectively realized by controlling the picking vehicle. Also, comparing to the picking vehicle that sucks the good by a vacuum chunk, this disclosure can move the goods of various sizes by the fork and the pushing component without being limited by the size of the vacuum chunk.

### BRIEF DESCRIPTION OF THE DRAWINGS

FIG. 1 is a perspective view of a picking vehicle according to one embodiment of the disclosure.

FIG. 2 is a side view of the picking vehicle in FIG. 1.

FIG. 3 is a partially enlarged perspective view of the picking vehicle in FIG. 1.

FIG. 4 is a partially enlarged perspective view of the picking vehicle in FIG. 3.

FIG. 5 is a block diagram of a picking system according to one embodiment of the disclosure.

FIG. 6 is a schematic perspective view the picking system in FIG. 5.

FIGS. 7 and 8 are partially enlarged perspective views of the picking system in FIG. 5.

FIGS. 9 to 11 are flow charts of a picking method according to one embodiment of the disclosure.

FIG. 12 a perspective view of a picking vehicle according to another embodiment of the disclosure.

### DETAILED DESCRIPTION

In the following detailed description, specific details and advantage of the embodiments of the disclosure are described in detail in order to provide a thorough understanding of the technical contents of the embodiments of the disclosure to those skilled in the art to allow the same to practice the disclosed embodiments, and those skilled in the art may easily understand the relevant purposes and advantages of the disclosure based on the content disclosed in this specification, claims and drawings. The embodiments below further described aspects of the disclosure in detail but do not limit the scope of the disclosure in any aspect.

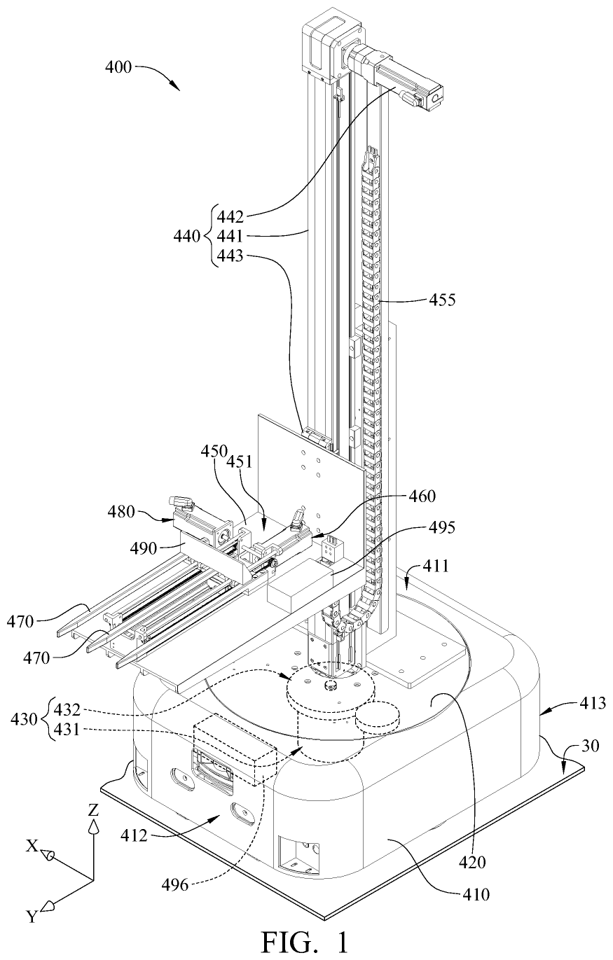

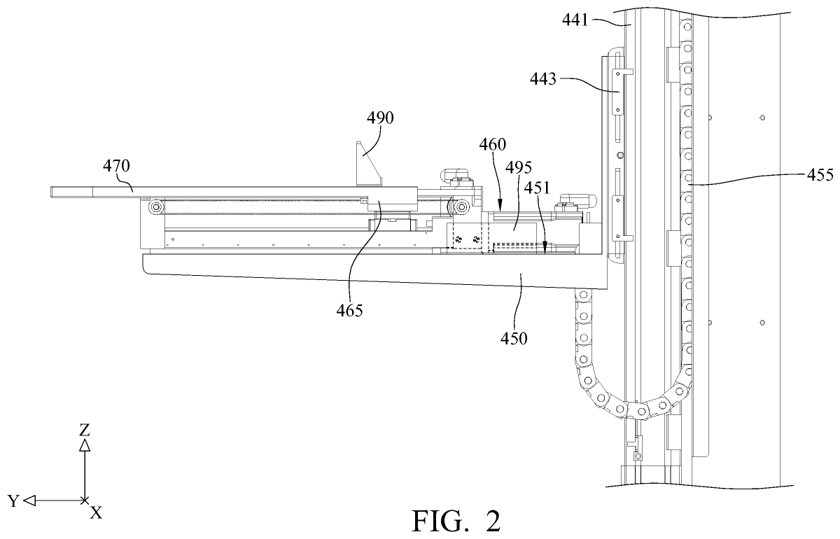

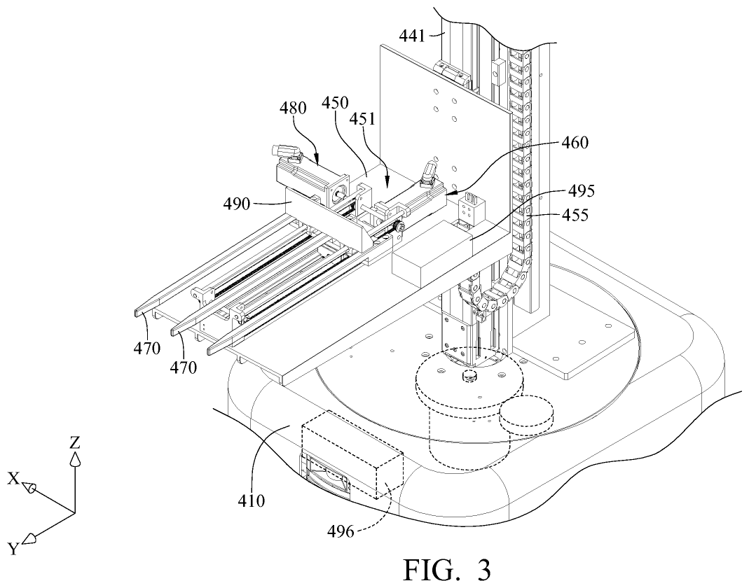

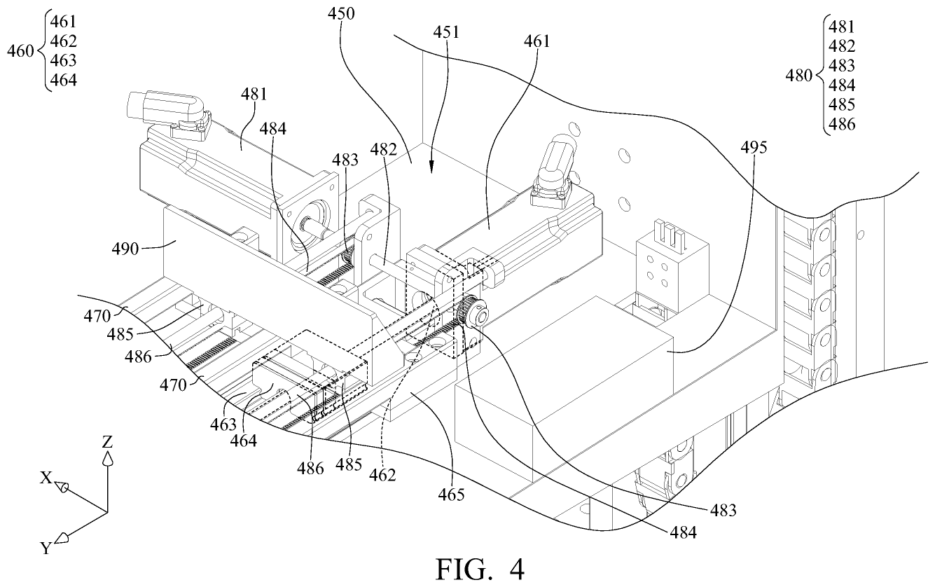

Please refer to FIGS. 1 to 4, where FIG. 1 is a perspective view of a picking vehicle according to one embodiment of the disclosure, FIG. 2 is a side view of the picking vehicle in FIG. 1, FIG. 3 is a partially enlarged perspective view of the picking vehicle in FIG. 1, and FIG. 4 is a partially enlarged perspective view of the picking vehicle in FIG. 3.

The picking vehicle 400 is, for example, an Automated Guided Vehicle (AGV) or an Autonomous Mobile Robots (AMR). In this embodiment, the picking vehicle 400 includes a movable base 410, a mounting plate 420, a rotating assembly 430, a lifting assembly 440, a mounting platform 450, a drive assembly 460 for fork, a fixing plate 465, a plurality of forks 470, a drive assembly 480 for pushing component and a pushing component 490.

As shown in FIG. 1, the movable base 410 is configured to move on the supporting surface 30. The movable base 410 has a top surface 411, a first side surface 412 and a second side surface 413. The first side surface 412 and the second side surface 413 face away from each other, and are connected to the top surface 411. The top surface 411 is configured to face away from the supporting surface 30.

As shown in FIG. 1, the mounting plate 420 is rotatably disposed on the top surface 411 via the rotating assembly 430. The rotating assembly 430 may include a drive unit 431 and a gear assembly 432. The drive unit 431 is, for example, a motor and is disposed in the movable base 410. The gear assembly 432 connects the drive unit 431 and the mounting plate 420, such that the drive unit 431 is configured to rotate the mounting plate 420 along, for example, Z-axis direction via the gear assembly 432.

As shown in FIGS. 1 and 2, the lifting assembly 440 includes a slide rail 441, a drive unit 442 and a slider 443. The slide rail 441 is, for example, a linear slide rail, and stands on the top surface 411 of the movable base 410. The drive unit 442 is, for example, a motor and disposed on the slide rail 441. The slider 443 is slidably disposed on the slide rail 441. The drive unit 442 is connected to the slider 443 via, for example, a belt (not shown) inside the slide rail 441, so as to drive the slider 443 to slide on the slide rail 441 along, for example, Z-axis direction. The drive unit 442 includes, for example, a reduction drive to transfer the rotational speed of the drive unit 442 into torque. The mounting platform 450 is fixed to the slider 443, and has a mounting surface 451. The mounting surface 451 faces away from the supporting surface 30.

As shown in FIGS. 1 and 2, the picking vehicle 400 may further include a chain 455. Two opposite sides of the chain 455 are fixed to the slide rail 441 and the mounting platform 450, respectively.

As shown in FIGS. 3 and 4, the drive assembly 460 for fork includes, for example, a drive unit 461, a connecting rod 462, a slide rail 463 and a slider 464. The drive unit 461 is, for example, a motor and is disposed on the mounting surface 451. The connecting rod 462 connects the drive unit 461 and the slide rail 463. The slide rail 463 is disposed on the mounting surface 451 of the mounting platform 450. The slider 464 is slidably disposed on the slide rail 463. The drive unit 461 is configured to drive the slider 464 to be moved toward or away from the slide rail 441 on the slide rail 463 via the connecting rod 462. The fixing plate 465 is fixed to the slider 464. The forks 470 are spaced apart from one another, and protrude from a side of the fixing plate 465. Additionally, in this embodiment, the mounting platform 450 is located between the forks 470 and the movable base 410. That is, the mounting platform 450 is disposed above the movable base 410. Thus, the picking vehicle 400 is able to move the good that is located far away from the supporting surface 30 (the good that is located at a higher position).

The drive assembly 480 for pushing component includes, for example, a drive unit 481, a connecting rod 482, two gears 483, two belts 484, two sliders 485 and two guiding rods 486. The drive unit 481 is, for example, a motor and disposed on the mounting surface 451. The connecting rod 482 is connected to the drive unit 481. The two gears 483 are sleeved and fixed on the connecting rod 482. The two belts 484 are engaged with the two gears 483, respectively. The two slider 485 are respectively fixed to the two belts 484, and slidably disposed on the mounting surface 451 of the mounting platform 450 via the guiding rods 486. The drive unit 481 is configured to drive the slider 485 to be moved toward or away from the slide rail 441 on the guiding rods 486 via the connecting rod 482, the gears 483 and the belts 484. The pushing component 490 is fixed on the two sliders 485. Moreover, the forks 470 are located between the pushing component 490 and the mounting surface 451.

The picking vehicle 400 may further include a controlling unit 495. The controlling unit 495 is disposed on the mounting surface 451, and is electrically connected to the drive units 461 and 481 on the mounting surface 451 via one or more cables (not shown). The one or more cables may be disposed in the chain 455 to be prevented from disturbing the operation of other components.

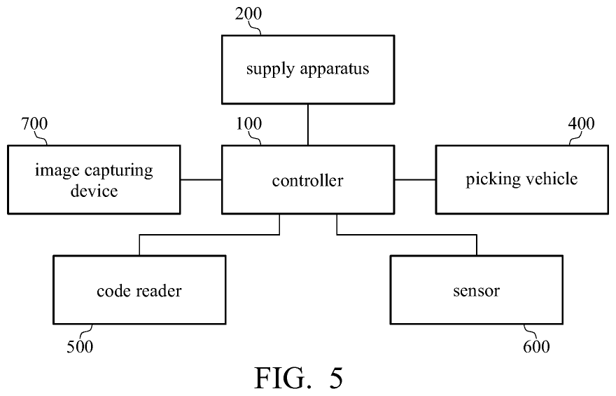

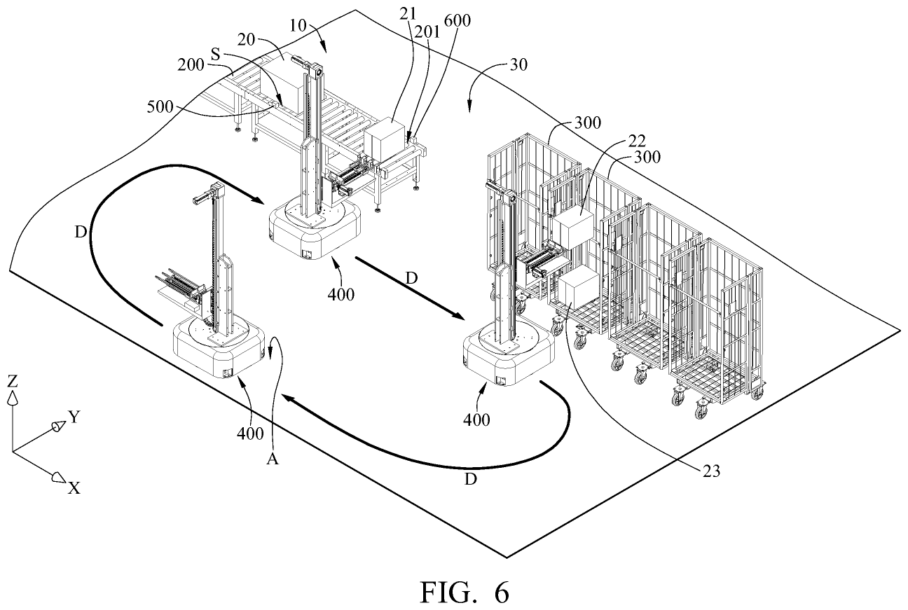

Next, a picking system 10 according to one embodiment of the disclosure will be described. Please refer to FIGS. 5 and 6, where FIG. 5 is a block diagram of a picking system according to one embodiment of the disclosure, and FIG. 6 is a schematic perspective view the picking system in FIG. 5. In this embodiment, the picking system 10 includes a controller 100, a supply apparatus 200, a plurality of racks 300 and a plurality of picking vehicles 400.

The supply apparatus 200 is, for example, a conveyor, and is electrically connected to the controller 100. The supply apparatus 200 is configured to transport one or more goods 20 and 21. The racks 300 are located on a side of the supply apparatus 200. The structure of the picking vehicle 400 has been described in detail by referring to FIGS. 1 to 4, and thus the repeated descriptions are omitted. The movable base 410 is configured to move between the supply apparatus 200 and the racks 300 on the supporting surface 30, and is electrically connected to the controller 100. For example, a circuit assembly 496 electrically connected to the controller 100 may be disposed in the movable base 410. The circuit assembly 496 may include computing computer and controlling module. The controlling unit 495 is electrically connected to the circuit assembly 496 via, for example, internet. The forks 470 are configured to support one or more goods 21 and 22. The pushing component 490 is configured to push the one or more goods 21 and 22 supported on the forks 470 into the racks 300.

In this embodiment, the picking system 10 may further include a code reader 500, a sensor 600 and an image capturing device 700. The code reader 500 is electrically connected to the controller 100, and is configured to read a barcode on the good 20. The sensor 600 is, for example, an infrared sensor or an image sensor. The sensor 600 is electrically connected to the controller 100, and is configured to detect the position of the good 21 on the supply apparatus 200. The image capturing device 700 is electrically connected to the controller 100, and is configured to capture image of the racks 300. In other embodiments, at least one of the code reader 500, the sensor 600 and the image capturing device 700 may be omitted according to actual requirements.

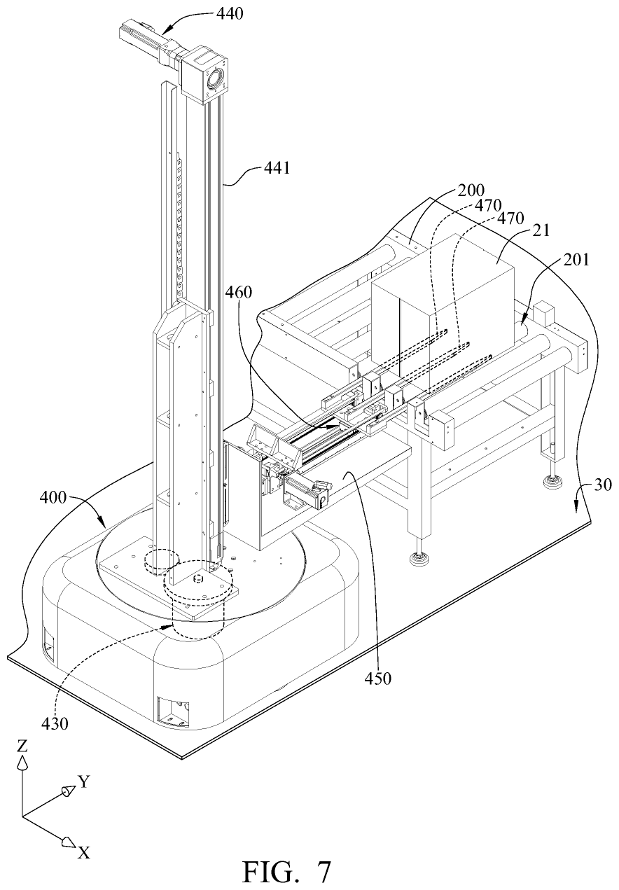

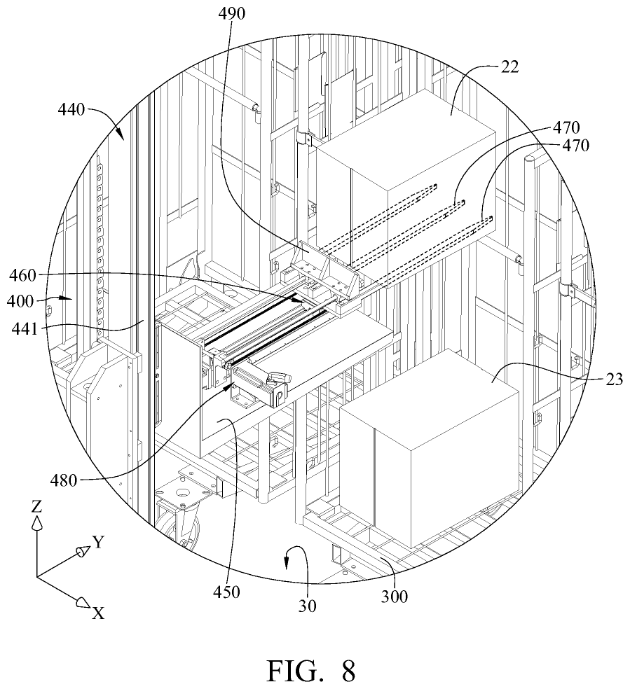

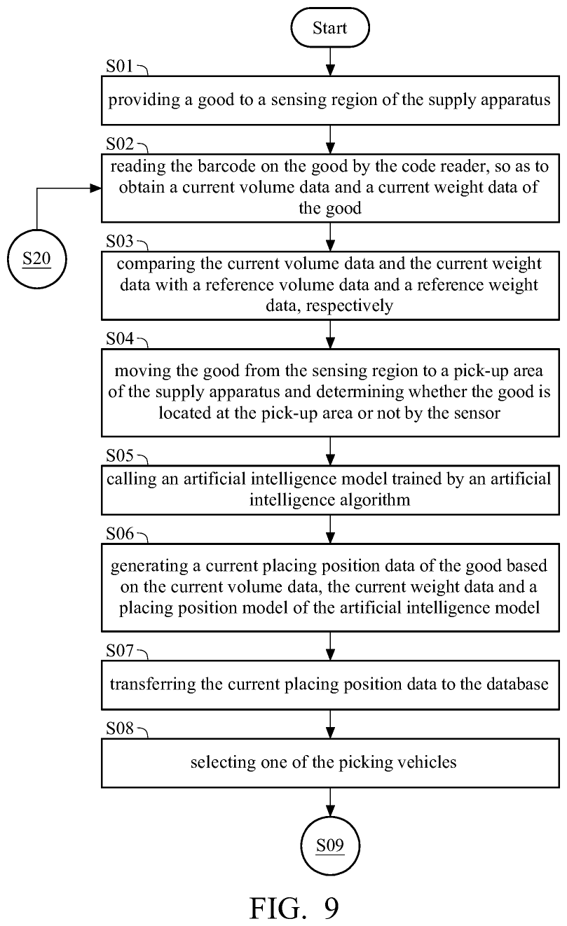

Hereinafter, a picking method according to one embodiment of the disclosure will be described. Please refer to FIGS. 6 to 11. FIGS. 7 and 8 are partially enlarged perspective views of the picking system in FIG. 5. FIGS. 9 to 11 are flow charts of a picking method according to one embodiment of the disclosure. For the convenience of illustration, the goods 20-23 labeled by different numerals are shown in FIG. 6. In practical, the goods 20-23 may be the same good that is in different picking stages. The following steps may be performed by, for example, the controller 100 in FIG. 5.

Please refer to FIGS. 6 and 9. A step S01 is firstly performed to provide a good 20 to a sensing region S of the supply apparatus 200 by, for example, a sorter. In other embodiments, the good may be manually provided to the sensing region.

Please refer to FIGS. 6 and 9. Then, a step S02 is performed to read the barcode on the good 20 by the code reader 500, so as to obtain a current volume data and a current weight data of the good 20. For example, the code may correspond to the code of the good, and the corresponding volume data and weight data may be obtained from a database based on the code of the good corresponding to the barcode.

Please refer to FIG. 9. Then, a step S03 is performed to compare the current volume data and the current weight data with a reference volume data and a reference weight data, respectively. If the current volume data and the current weight data do not match the reference volume data and the reference weight data, respectively, a warning signal may be generated to notify a technician to deal with the error.

Please refer to FIGS. 6 and 9. If the current volume data and the current weight data match the reference volume data and the reference weight data, respectively, a step S04 is performed to move the good 21 from the sensing region S to a pick-up area 201 of the supply apparatus 200 and to determine whether the good 21 is located at the pick-up area 201 or not by the sensor 600. The pick-up area 201 is located at, for example, an end of the supply apparatus 200. If the sensor 600 determines that the good 21 is not located at the pick-up area 201, a warning signal may be generated to notify a technician to deal with the error. If the sensor 600 determines that the good 21 is located at the pick-up area 201, a step S05 is performed to call an artificial intelligence model trained by an artificial intelligence algorithm.

Please refer to FIG. 9. Then, a step S06 is performed to generated a current placing position data of the good 21 based on the current volume data, the current weight data and a placing position model of the artificial intelligence model. In this embodiment, the current placing position data includes a target rack data and a target stacking position data. The placing position model includes a plurality of placing data. Each placing datum includes multiple groups of a predetermined volume data, a predetermined weight data and a predetermined placing position data that are corresponding to one another. In this embodiment, the predetermined placing position data includes a predetermined rack data and a predetermined stacking position data. Specifically, the target rack data and the predetermined rack data indicate which of the racks 300 should the good 21 to be placed. The target stacking position data and the predetermined stacking position data indicate where should the good 21 to be placed in the indicated rack 300.

In other embodiments, the picking system may include one rack. In such embodiments, the current placing position data may not include the target rack data, and the predetermined placing position data may not include the predetermined rack data.

In this or other embodiments, the artificial intelligence model may be trained by multiple training data and a generative artificial intelligence (GAI) algorithm in a supervised manner. Each training datum may include a volume data and a weight data, and each training datum has a label indicating one of multiple predetermined placing position. The artificial intelligence model is, for example, ChatGPT, Databricks-Dolly 2.0 or Meta-Llama 2, and may be trained by at least one of Parameter Efficient Fine Tuning (PEFT), Low-Rank Adaptation (LoRA) and Cutting-Stock Algorithm. For example, one thousand or more of training data corresponding to an occupancy rate of 85% or higher may be randomly generated by using the Cutting-Stock Algorithm, and such training data can be transformed into multiple predetermined placing position data corresponding to an average occupancy rate of 94%.

In this embodiment, the step S04 of determining the position of the good 21 is performed before the step S05 of calling the artificial intelligence model, but the disclosure is not limited thereto. In other embodiments, the step S05 may be performed before the step S04, or the steps S04 and S05 may be simultaneously performed.

Please refer to FIG. 9. Then, a step S07 is performed to transfer the current placing position data to the database.

Please refer to FIGS. 6 and 9. Then, a step S08 is performed to select one of the picking vehicles 400.

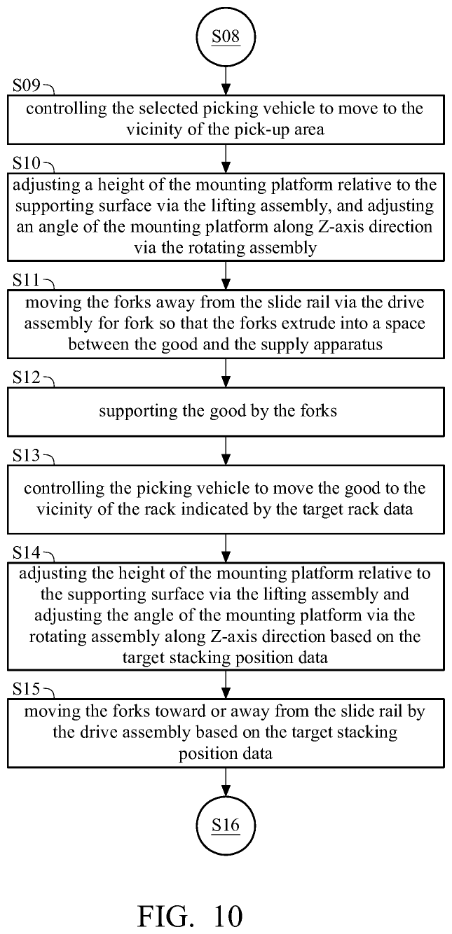

Please refer to FIGS. 7 and 10. Then, a step S09 is performed to control the selected picking vehicle 400 to move to the vicinity of the pick-up area 201.

Please refer to FIGS. 7 and 10. Then, a step S10 is performed to adjust a height of the mounting platform 450 relative to the supporting surface 30 via the lifting assembly 440, and to adjust an angle of the mounting platform 450 along Z-axis direction via the rotating assembly 430.

Please refer to FIGS. 7 and 10. Then, a step S11 is performed to move the forks 470 away from the slide rail 441 via the drive assembly 460 for fork so that the forks 470 extrude into a space between the good 21 and the supply apparatus 200.

Please refer to FIGS. 7 and 10. Then, a step S12 is performed to support the good 21 by the forks 470.

Please refer to FIGS. 8 and 10. Then, steps S13 to S18 are performed to move the good 22 to a target placing position via the picking vehicle 400 based on the current placing position data.

In detail, please refer to FIGS. 8 and 10. The step S13 is firstly performed to control the picking vehicle 400 to move the good 22 to the vicinity of the rack 300 indicated by the target rack data. Further, please refer back to FIG. 6, the three picking vehicles 400 in FIG. 6 may be assigned to the vicinity of the supply apparatus 200, the vicinity of the racks 300 and a standby region A located on a side of the racks 300 along an assigning direction D, respectively. The picking vehicle 400 located at the standby region A may be assigned to the vicinity of the supply apparatus 200 during the next cycle of the picking method.

Please refer to FIGS. 7, 8 and 10. Then, a step S14 is performed to adjust the height of the mounting platform 450 relative to the supporting surface 30 via the lifting assembly 440 and to adjust the angle of the mounting platform 450 via the rotating assembly 430 along Z-axis direction based on the target stacking position data.

Please refer to FIGS. 8 and 10. Then, a step S15 is performed to move the forks 470 toward or away from the slide rail 441 by the drive assembly 460 based on the target stacking position data. Additionally, when the forks 470 are moved, an interference between the fork 470 and the rack 300 or an interference between the fork 470 and the good 23 than has been placed in the rack 300 may be prevented by a dynamic tracking algorithm.

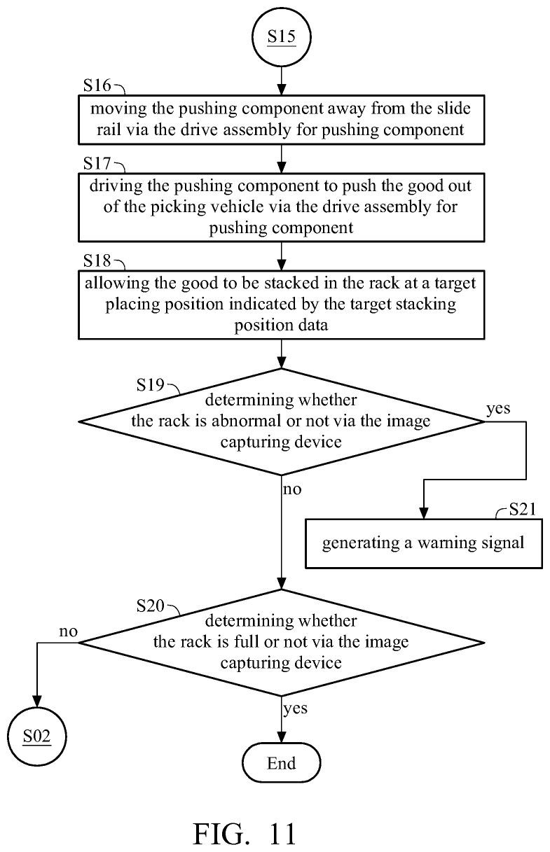

Please refer to FIGS. 8 and 11. Then, a step S16 is performed to move the pushing component 490 away from the slide rail 441 via the drive assembly 480 for pushing component.

Please refer to FIGS. 8 and 11. Then, a step S17 is performed to drive the pushing component 490 to push the good 22 out of the picking vehicle 400 via the drive assembly 480 for pushing component.

Please refer to FIGS. 8 and 11. Then, a step S18 is performed to allow the good 23 to be stacked in the rack 300 at a target placing position indicated by the target stacking position data. The target placing position indicated by the target stacking position data is located at the rack 300 indicated by the target rack data.

Please refer to FIG. 11. Then, a step S19 is performed to determine whether the rack 300 is abnormal or not via the image capturing device 700. If the rack 300 is normal, a step S20 is performed to determine whether the rack 300 is full or not via the image capturing device 700. If the rack 300 is full, the picking method is ended. If the rack 300 is not full, the steps S02-S19 are repeated.

For example, the image capturing device 700 may capture one or more of depth image, infrared image and RGB image. Also, a rack coordinate system may be built by analyzing the structure of the rack, an outline of the good may be identified by analyzing the difference between multiple images, and the state of the good may be identified by the tracking of the good. Accordingly, the vortexes and height of the rack may be analyzed, the difference between depth features may be analyzed, and the position and state of the good may be tracked. In this way, the image capturing device 700 may determine whether the good 23 is abnormal or not and whether the rack 300 is full or not. For example, if the good 23 is misaligned with other good in the rack 300 or protrudes out of the rack 300, the rack 300 will be determined to be abnormal; if the space in the rack 300 accommodating the good occupies a certain percentage of the overall space of the rack 300 or more, the rack 300 is determined to be full.

If the rack 300 is abnormal, a step S21 is preformed to generate a warning signal to notify the technician to deal with the error.

In the picking vehicle 400 shown in FIGS. 1 to 4, the mounting platform 450 is disposed above the movable base 410, but the disclosure is not limited thereto.

Other embodiments are described below for illustrative purposes. The following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

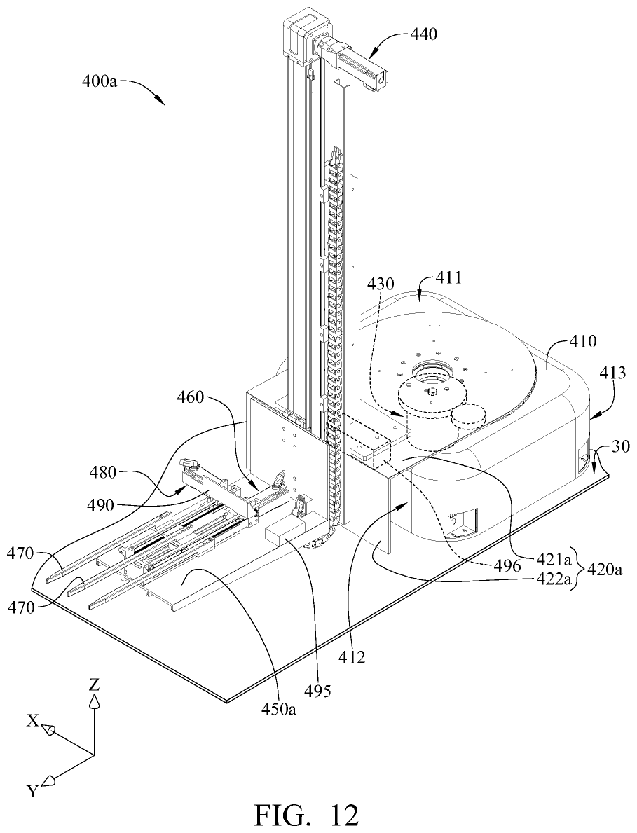

Please refer to FIG. 12. FIG. 12 a perspective view of a picking vehicle according to another embodiment of the disclosure. In this embodiment, the picking vehicle 400a includes the movable base 410, a mounting plate 420a, the rotating assembly 430, the lifting assembly 440, a mounting platform 450a, the drive assembly 460 for fork, the fixing plate 465, the forks 470, the drive assembly 480 for pushing component and the pushing component 490. The mounting plate 420a includes, for example, a first plate part 421a and a second plate part 422a. The second plate part 422a stands on a side of the first plate part 421a. The first plate part 421a is disposed on the top surface 411, and is connected to the rotating assembly 430. The second plate part 422a is located on a side of the first side surface 412 that is located farthest away from the second side surface 413. The mounting platform 450a protrudes from the second plate part 422a, and the first side surface 412 is located between the mounting platform 450a and the second side surface 413. Accordingly, the picking vehicle 400a can have larger operation space and can be used to move the goods that is located close to the supporting surface 30 (the goods having smaller height).

According to the picking method, the picking vehicle and the picking system disclosed by above embodiments, the current placing position data of the good is generated based on the current volume data, the current weight data and the placing position model of the artificial intelligence model. Thus, the trained artificial intelligence model can determine the optimized placing position of the good based on the volume and weight of the good. In this way, not only the goods are prevented from being misaligned in the rack or protruding out of the rack, but also the occupancy rate of the rack is allowed to be higher than a desired level, thereby effectively realizing the automation of the picking processes.

In addition, by the fork and the pushing component that are movably disposed on the mounting surface of the mounting platform, the picking vehicle can move the good and push the good into the rack. Accordingly, the automation of the picking processes is effectively realized by controlling the picking vehicle. Also, comparing to the picking vehicle that sucks the good by a vacuum chunk, this disclosure can move the goods of various sizes by the fork and the pushing component without being limited by the size of the vacuum chunk.

Although the embodiments of the disclosure are disclosed above, the disclosure is not limited by the embodiments. It will be apparent to those skilled in the art that various modifications and variations can be made to the disclosed embodiments. Thus, the protection scope of the disclosure is defined by the following appended claims.

### DESCRIPTION OF NUMERALS

10: picking system
100: controller
200: supply apparatus
201: pick-up area
300: rack
400: picking vehicle
410: movable base
411: top surface
412: first side surface
413: second side surface
420: mounting plate
430: rotating assembly
431: drive unit
432: gear assembly
440: lifting assembly
441: slide rail
442: drive unit
443: slider
450: mounting platform
451: mounting surface
455: chain
460: drive assembly for fork
461: drive unit
462: connecting rod
463: slide rail
464: slider
465: fixing plate
470: fork
480: drive assembly for pushing component
481: drive unit
482: connecting rod
483: gear
484: belt
485: slider
486: guiding rod
490: pushing component
495: controlling unit
496: circuit assembly
500: code reader
600: sensor
700: image capturing device
400a: picking vehicle
420a: mounting plate
421a: first plate part
422a: second plate part
450a: mounting platform
20, 21, 22, 23: good
30: supporting surface
S01˜S20: steps
D: assigning direction
A: standby region
S: sensing region

1. A picking method, comprising:
obtaining a current volume data and a current weight data of a good;
generating a current placing position data of the good based on the current volume data, the current weight data and a placing position model of an artificial intelligence model, wherein the placing position model comprises a plurality of placing data, and each of the plurality of placing data comprises a plurality of groups of a predetermined volume data, a predetermined weight data and a predetermined placing position data that are corresponding to one another; and
moving the good to a target placing position via a picking vehicle based on the current placing position data.

2. The picking method according to claim 1, wherein the current placing position data comprises a target rack data and a target stacking position data, the predetermined placing position data comprises a predetermined rack data and a predetermined stacking position data, and the picking vehicle moves the good to the target placing position located at one of a plurality of racks.

3. The picking method according to claim 1, wherein before obtaining the current volume data and the current weight data of the good, the picking method further comprises providing a good to a sensing region of a supply apparatus.

4. The picking method according to claim 1, wherein after obtaining the current volume data and the current weight data of the good, the picking method further comprises comparing the current volume data and the current weight data with a reference volume data and a reference weight data, respectively, if the current volume data and the current weight data match the reference volume data and the reference weight data, respectively, the current placing position data of the good is generated based on the current volume data, the current weight data and the placing position model of the artificial intelligence model.

5. The picking method according to claim 3, wherein before moving the good to the target placing position via the picking vehicle based on the current placing position data, the picking method further comprises moving the good from the sensing region to a pick-up area on the supply apparatus and determining whether the good is located at the pick-up area or not by a sensor, if the good is located at the pick-up area, the good is moved to the target placing position via the picking vehicle based on the current placing position data.

6. The picking method according to claim 1, wherein after moving the good to the target placing position via the picking vehicle based on the current placing position data, the picking method further comprises determining whether the rack is abnormal or not via an image capturing device.

7. The picking method according to claim 1, wherein after moving the good to the target placing position via the picking vehicle based on the current placing position data, the picking method further comprises determining whether the rack is full or not via an image capturing device.

8. A picking vehicle, configured to move on a supporting surface and comprising:
a movable base, configured to move on the supporting surface;
a mounting platform, movably disposed on the movable base and having a mounting surface facing away from the supporting surface;
at least one fork, movably disposed on the mounting surface of the mounting platform; and
a pushing component, movably disposed on the mounting surface of the mounting platform, wherein the at least one fork is located between the pushing component and the mounting surface.

9. The picking vehicle according to claim 8, wherein the mounting platform is located between the at least one fork and the movable base.

10. The picking vehicle according to claim 8, wherein the movable base has a top surface, a first side surface and a second side surface, the first side surface and the second side surface face away from each other and are connected to the top surface, the top surface is configured to face away from the supporting surface, and the first side surface is located between the mounting platform and the second side surface.

11. The picking vehicle according to claim 8, further comprising a mounting plate and a rotating assembly, wherein the mounting plate is rotatably disposed on a side of the movable base that is located farthest away from the supporting surface via the rotating assembly, the mounting platform is disposed on the mounting plate, the rotating assembly comprises a drive unit and a gear assembly, the drive unit is disposed in the movable base, and the gear assembly connects the drive unit and the mounting plate so that the drive unit is configured to rotate the mounting plate via the gear assembly.

12. The picking vehicle according to claim 8, further comprising a lifting assembly, wherein the lifting assembly comprises a slide rail, a drive unit and a slider, the slide rail stands on a side of the movable base that is located farthest away from the supporting surface, the drive unit is disposed on the slide rail, the slider is slidably disposed on the slide rail, the drive unit is connected to the slider to drive the slider to slide on the slide rail, and the mounting platform is fixed to the slider.

13. The picking vehicle according to claim 12, further comprises a chain, wherein two opposite sides of the chain are fixed to the slide rail and the mounting platform, respectively.

14. The picking vehicle according to claim 8, further comprising a drive assembly for the at least one fork, wherein the drive assembly for the at least one fork comprises a drive unit, a connecting rod, a slide rail and a slider, the drive unit is disposed on the mounting surface, the connecting rod connects the drive unit and the slide rail, the slide rail is disposed on the mounting surface, the slider is slidably disposed on the slide rail, the drive unit is configured to drive the slider to slide on the slide rail via the connecting rod, and the at least one fork is fixed to the slider.

15. The picking vehicle according to claim 8, further comprising a drive assembly for the pushing component, wherein the drive assembly for the pushing component comprises a drive unit, a connecting rod, two gears, two belts, two sliders and two guiding rods, the drive unit is disposed on the mounting surface, the connecting rod is connected to the drive unit, the two gears are sleeved and fixed on the connecting rod, the two belts are engaged with the two gears, respectively, the two sliders are fixed to the two belts, respectively, the two sliders are slidably disposed on the mounting surface via the two guiding rods, respectively, the drive unit is configured to drive the two sliders to slide on the two guiding rods via the connecting rod, the two gears and the two belts, and the pushing component is fixed to the two sliders.

16. The picking vehicle according to claim 14, further comprising a controlling unit disposed on the mounting surface and electrically connected to the drive unit.

17. A picking system, configured to pick one or more goods and comprising:
a controller;
a supply apparatus, electrically connected to the controller and configured to transport the one or more good;
at least one rack, located on a side of the supply apparatus; and
at least one picking vehicle, comprising:
a movable base, configured to move between the supply apparatus and the at least one rack on a supporting surface and electrically connected to the controller;
a mounting platform, movably disposed on the movable base and having a mounting surface facing away from the supporting surface;
at least one fork, movably disposed on the mounting surface of the mounting platform and configured to support the one or more good; and
a pushing component, movably disposed on the mounting surface of the mounting platform, wherein the at least one fork is located between the pushing component and the mounting surface, and the pushing component is configured to push the one or more goods supported by the at least one fork into the at least one rack.

18. The picking system according to claim 17, wherein the picking system further comprises an image capturing device electrically connected to the controller, the image capturing device is configured to capture an image of the at least one rack.

19. The picking system according to claim 17, wherein the picking system further comprises a sensor electrically connected to the controller, and the sensor is configured to detect one or more position of the one or more goods on the supply apparatus.

20. The picking system according to claim 17, wherein the picking system further comprises a code reader electrically connected to the controller, and the code reader is configured to read one or more barcodes on the one or more goods.
